(19) United States
(12) Patent Application Publication
(10) Pub. No.: US 2025/0060317 A1
(43) Pub. Date: Feb. 20, 2025

(54) SYSTEM AND METHOD FOR DURATION-BASED SAMPLE PATH ADJUSTMENT

(71) Applicant: KLA Corporation, Milpitas, CA (US)

(72) Inventor: Arthur Kalman, Bustan HaGalil (IL)

(21) Appl. No.: 18/529,854

(22) Filed: Dec. 5, 2023

Related U.S. Application Data
(60) Provisional application No. 63/532,422, filed on Aug. 14, 2023.

(51) Int. Cl. G01N 21/88

(52) U.S. Cl. CPC G01N 21/8851; G01N 21/9501; G01N 2201/117

(57) ABSTRACT

A method for duration-based sample path adjustment includes receiving an initial sample map. The method includes generating one or more adjusted sample maps including one or more adjusted paths of the set of site points of the initial sample map. The method includes generating a final sample map of the sample based on the one or more adjusted paths, where the final sample map includes a final path. The method includes directing an optical sub-system to perform one or more operations on the sample based on the final sample map. The optical sub-system performs the one or more operations by following the final path of the set of site points on the sample, where at least one of the first duration or the first distance of the initial path are greater than at least one of the second duration or the second distance of the final path.

### CROSS-REFERENCE TO RELATED APPLICATIONS

The present application claims the benefit under 35 U.S.C. § 119 (e) of U.S. Provisional Application Ser. No. 63/532,422, filed Aug. 14, 2023, which is incorporated herein by reference in the entirety.

### TECHNICAL FIELD

The present invention generally relates to sample path adjustment, and, more particularly, to a system and method for duration-based sample path adjustment.

### BACKGROUND

As the demand for integrated circuits having ever-small device features continues to increase, the need for improved optical systems continues to grow. Optical systems such as defect detection systems often utilize sample site maps to indicate where on the sample the optical system needs to pass. The path between sites on a sample are determined based on an algorithm. Existing techniques are based on distance only algorithms (e.g., Intra Field, Nearest Neighbor, and the like), where distance is the only factor used when determining which path the optical system should take. Such methods create paths usually have very long strokes, which negatively impact the final path. Additionally some techniques (e.g., Simulated Annealing, and the like) are stochastic and do not enable other optimization to be used. Other noticeable disadvantages of the existing approaches are that such algorithms do not take advantage of system's motion characteristics, the path does not start and end at the best locations, the path contains very long (unnecessary) strokes, and the path contains crossings. As such, it would be advantageous to provide system and method to remedy the shortcomings of the approaches identified above.

### SUMMARY

A method for duration-based path adjustment is disclosed, in accordance with one or more embodiments of the present disclosure. In embodiments, the method includes receiving an initial sample map, where the initial sample map includes an initial path including a set of site points and the initial path includes a first duration and a first distance. In embodiments, the method includes generating one or more adjusted sample maps including one or more adjusted paths of the set of site points of the initial sample map, where each adjusted path is generated by adjusting an order of arrival of the set of site points based on a cost function. In embodiments, the method includes generating a final sample map of the sample based on the one or more adjusted paths, where the final sample map includes a final path generated based on the one or more adjusted order of arrivals of the set of site points. In embodiments, the method includes directing an optical sub-system to perform one or more operations on the sample based on the final sample map. In embodiments, the optical sub-system performs the one or more operations by following the final path of the set of site points on the sample, where the final path has a second duration and a second distance, and where at least one of the first duration or the first distance of the initial path are greater than at least one of the second duration or the second distance of the final path.

A system for duration-based path adjustment is disclosed, in accordance with one or more embodiments of the present disclosure. In embodiments, the system includes a controller including one or more processors. In embodiments, the one or more processors are configured to execute program instructions causing the one or more processors to receive an initial sample map of a sample, where the initial sample map includes an initial path including a set of site points, wherein the initial path includes a first duration and a first distance. In embodiments, the one or more processors are configured to execute program instructions causing the one or more processors to generate one or more adjusted sample maps including one or more adjusted paths of the set of site points of the initial sample map, where each adjusted path is generated by adjusting an order of arrival of the set of site points based on a cost function. In embodiments, the one or more processors are configured to execute program instructions causing the one or more processors to generate a final sample map of the sample based on the one or more adjusted paths, where the final sample map includes a final path generated based on the one or more adjusted order of arrivals of the set of site points. In embodiments, the one or more processors are configured to execute program instructions causing the one or more processors to direct an optical sub-system to perform one or more operations on the sample based on the final sample map, where the optical sub-system performs the one or more operations by following the final path of the set of site points on the sample, where the final path has a second duration and a second distance, where at least one of the first duration or the first distance of the initial path are greater than at least one of the second duration or the second distance of the final path.

A system for duration-based path adjustment is disclosed, in accordance with one or more embodiments of the present disclosure. In embodiments, the system includes an optical sub-system. In embodiments, the system includes a controller including one or more processors. In embodiments, the one or more processors are configured to execute program instructions causing the one or more processors to receive an initial sample map of a sample, where the initial sample map includes an initial path including a set of site points, wherein the initial path includes a first duration and a first distance. In embodiments, the one or more processors are configured to execute program instructions causing the one or more processors to generate one or more adjusted sample maps including one or more adjusted paths of the set of site points of the initial sample map, where each adjusted path is generated by adjusting an order of arrival of the set of site points based on a cost function. In embodiments, the one or more processors are configured to execute program instructions causing the one or more processors to generate a final sample map of the sample based on the one or more adjusted paths, where the final sample map includes a final path generated based on the one or more adjusted order of arrivals of the set of site points. In embodiments, the one or more processors are configured to execute program instructions causing the one or more processors to direct the optical sub-system to perform one or more operations on the sample based on the final sample map, where the optical sub-system performs the one or more operations by following the final path of the set of site points on the sample, where the final path has a second duration and a second distance, where at least one of the first duration or the first distance of the initial path are greater than at least one of the second duration or the second distance of the final path.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures.

FIG. 1 is a simplified block diagram of a system for duration-based path optimization, in accordance with one or more embodiments of the present disclosure.

FIG. 2 is a flow diagram depicting a method for duration-based sample path adjustment, in accordance with one or more embodiments of the present disclosure.

FIG. 3 is a simplified schematic of an initial sample map of a sample, in accordance with one or more embodiments of the present disclosure.

FIG. 4 is a process flow diagram depicting a method for duration-based sample path adjustment, in accordance with one or more embodiments of the present disclosure.

FIG. 5 is a simplified schematic of a sample map including an initial rough zigzag path, in accordance with one or more embodiments of the present disclosure.

FIG. 6A is a simplified schematic of a sample map including one or more identified relocation points, in accordance with one or more embodiments of the present disclosure.

FIG. 6B is a simplified schematic of an adjusted sample map, in accordance with one or more embodiments of the present disclosure.

FIG. 7A is a simplified schematic of a sample map including a crossing area, in accordance with one or more embodiments of the present disclosure.

FIG. 7B is a simplified schematic of an adjusted sample map without the crossing area, in accordance with one or more embodiments of the present disclosure.

FIG. 8A is a simplified schematic of a sample map including one or more identified section relocation points, in accordance with one or more embodiments of the present disclosure.

FIG. 8B is a simplified schematic of an adjusted sample map, in accordance with one or more embodiments of the present disclosure.

FIG. 9 is a simplified schematic view of an inspection sub-system of the system, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

Embodiments of the present disclosure are directed to a system and method for duration-based sample path adjustment. In particular, embodiments of the present disclosure are directed to a system and method for duration-based sample path adjustment using one or more sample path adjustment algorithms (or models) based on duration. For example, the individual sample path adjustment algorithms (or models) may be configured to apply a cost function to determine the “best” path for a given sample map. For instance, the “best” path may be determined based on the duration of the path for the given sample map.

It is contemplated herein that duration-based sample path technique as disclosed herein may provide numerous benefits. For example, the system and method of the present disclosure selects a final path having the shortest duration (or shortest path). By way of another example, the system and method of the present disclosure may reduce the larges stroke which helps to improve navigation accuracy. By way of another example, the system and method of the present disclosure may utilize one or more path algorithms that are fully determinist to enable additional optimizations to be done.

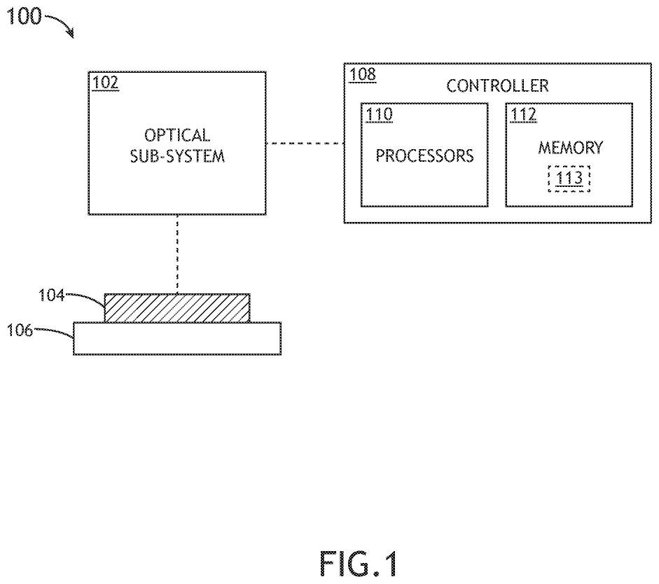

FIG. 1 illustrates a simplified block diagram of a system 100 for duration-based sample path adjustment, in accordance with one or more embodiments of the present disclosure. In embodiments, the system 100 includes an optical sub-system 10 configured to perform one or more operations on one or more samples disposed on a sample stage 106. In embodiments, the system 100 includes a controller 108 communicatively coupled to the optical sub-system 102. The controller 108 includes one or more processors 110 configured to execute program instructions maintained on a memory medium 112 (memory 112). The one or more processors 110 of the controller 108 may execute any of the various process steps described throughout the present disclosure.

In embodiments, the one or more processors 110 may be configured to receive an initial sample map of a sample, where the initial sample map includes an initial path including a set of site points.

For purposes of the present disclosure, the term “sample map” or “site map” is defined as a map including a set of points (or sites) where an optical sub-system will need to pass. For purposes of the present disclosure, the term “path” is defined as a specific order of map points (or sites) on the given sample map. For purposes of the present disclosure, the term “raw path” or “initial path” is defined as an initial order of points (or sites) on a sample before any adjustment has occurred. For example, the “raw path” or “initial path” may be received from an optical sub-system, remote database, or an external sub-system.

In embodiments, the one or more processors 110 may be configured to generate one or more adjusted paths of the set of site points of the initial sample map, where each adjusted path is generated by adjusting an order of arrival of the set of site points based on a cost function. For purposes of the present disclosure, the term “adjusted path” is defined as a temporary order of points (or sites) on a sample after adjustments have occurred.

In embodiments, the one or more processors 110 may be configured to generate an adjusted sample map of the sample based on the one or more adjusted paths, where the adjusted sample map includes a final path generated based on the one or more adjusted order of arrivals of the set of site points. For example, the generated final path may include a duration-based sample path utilized by the optical sub-system 102 such as, but not limited to, an inspection sub-system, metrology sub-system, lithography sub-system, or the like to perform one or more operations based on the duration-based sample path. In this regard, a final sample path is selected based on a duration of a given path for a given sample map, where selected sample path has a shorter duration compared to the initial sample map (or raw map).

In embodiments, the one or more processors 110 may be configured to direct the optical sub-system 102 to perform the one or more operations on the sample 104 based on the adjusted sample map, where the optical sub-system 102 performs the one or more operations by following the final path of the set of site points on the sample. For purposes of the present disclosure, the term “final path” is defined as a final order of points (or sites) on a sample after adjustments have occurred, where the optical sub-system performs one or more operations based on the final path.

It is noted that the optical sub-system 102 may include any type of optical sub-system 102 known in the art. For example, the optical sub-system 102 may include an inspection sub-system (or an inspection tool). For instance, the inspection sub-system may include an optical-based inspection tool such as, but is not limited to, a bright-field inspection sub-system, a dark-field inspection system, or the like. By way of another example, the optical sub-system 102 may include a metrology sub-system (or a metrology tool). For instance, the metrology sub-system may include an optical-based metrology tool. By way of another example, the optical sub-system 102 may include a lithography sub-system (or a lithography tool). The one or more samples 104 may include any sample known in the art including, but not limited to, a wafer, a reticle/photomask, and the like.

The sample stage assembly 106 may include any sample stage assembly 106 known in the art including, but not limited to, an X-Y stage, an R-θ stage, and the like. In embodiments, the sample stage assembly 106 is capable of adjusting the height of the one or more samples 104 during inspection or imaging to maintain focus on the one or more samples 104.

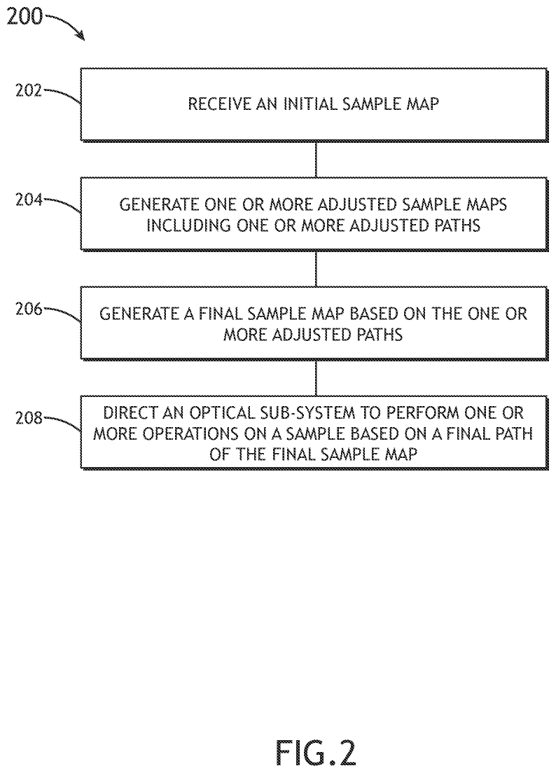

FIG. 2 illustrates a flow diagram for a method 200 for duration-based sample path adjustment, in accordance with one or more embodiments of the present disclosure. It is noted herein that the steps of the method 200 may be implemented all or in part by the system 100. It is further recognized, however, that the method 200 is not limited to the system 100 in that additional or alternative system-level embodiments may carry out all or part of the steps of the method 200.

In a step 202, one or more initial samples maps may be acquired. For example, the controller 108 may be configured to receive one or more initial sample maps. In embodiments, the controller 108 may be configured to receive one or more initial sample maps from the optical sub-system 102, from a remote database, or an external sub-system. For example, the initial sample map may be based on a plurality of predetermination locations on a sample. For instance, the initial sample map may be based on a plurality of test sites on a sample (e.g., wafer).

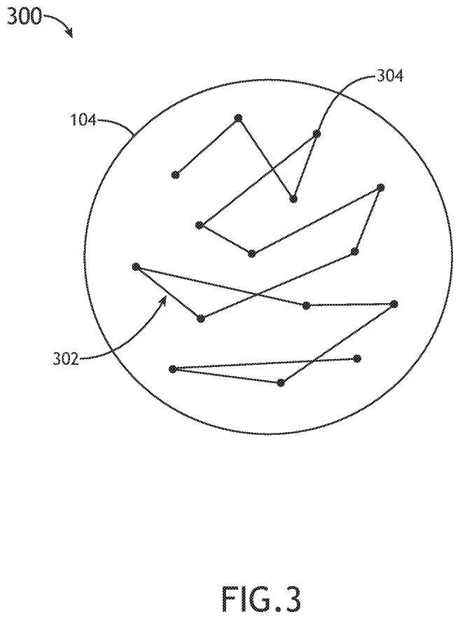

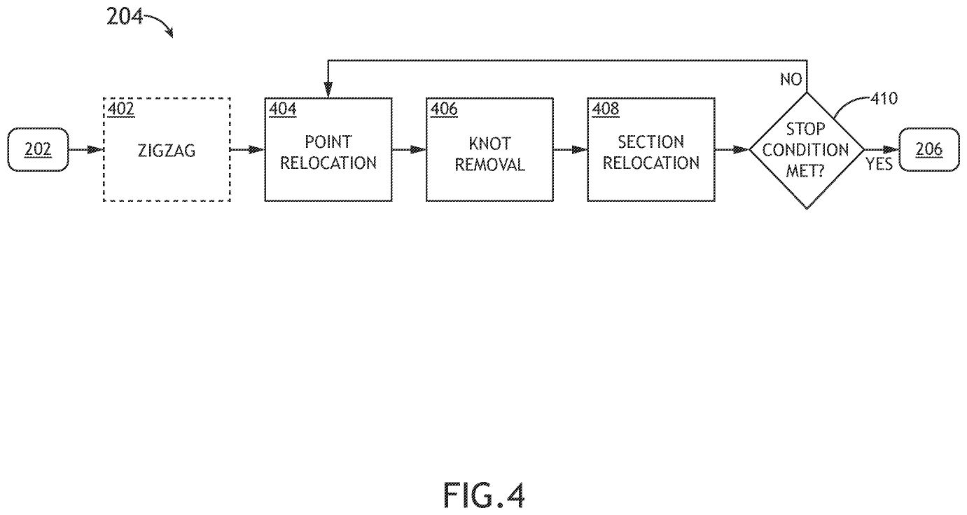

FIG. 3 illustrates an initial sample map 300 of the sample 104, in accordance with one or more embodiments of the present disclosure.

In embodiments, the one or more initial sample maps 300 of the sample 104 may include an initial path 302, where the initial path 302 is formed of a set of site points 304 on the sample 104. For example, the initial path 302 of the set of site points 304 on the sample 104 may correspond to site points 304 on the sample 104 that the optical sub-system 102 needs to pass during operation. In one instance, where the optical sub-system 102 includes an inspection sub-system, the set of site points 304 may include a set of inspection points 304 on the sample 104. In another instance, where the optical sub-system 102 includes a metrology sub-system, the set of site points 304 may include a set of metrology points 304 on the sample 104. In another instance, where the optical sub-system 102 includes a lithography sub-system, the set of site points 304 may include a set of lithography site points 304 on the sample 104.

In a step 204, the initial path 302 of the set of site points 304 may be adjusted. For example, the controller 108 may be configured to generate one or more adjusted paths by adjusting an order of arrival of the set of site points 304 on the initial sample map 400. For example, the controller 108 may be configured to apply one or more path adjustment algorithms 113 stored in memory 112 to generate the one or more adjusted paths. For instance, the controller 108, using the one or more path adjustment algorithms 113, may be configured to apply one or more cost functions to adjust the order of arrival of the set of site points 304 on a given sample map.

Although embodiments of the present disclosure are directed towards using a cost function to adjust the order of arrival, it is contemplated herein that the system 100 may utilize any type of mathematical construct or statistical model suitable for finding the best path based on the duration (or length) associated with the respective path.

It is contemplated herein that the cost function used by the one or more path adjustment algorithms may be used as a criterion during path comparison to determine whether one solution (e.g., path, in this case) is better or worse than another solution (e.g., path). As previously discussed herein, the duration-based technique as discussed herein, may determine the shortest path (or shortest path duration) based on the respective cost function.

The cost function may be based on a duration associated with performing one or more operations based on the respective path. For example, the path distance of the given sample map may be converted to duration based on the optical sub-system actual motion characteristics. For instance, the controller 108 may be configured to calculate an actual duration of any given distance on the sample map based on the system's motion parameters. The cost function may be further based on one or more additional parameters such as, but not limited to, distance, accuracy, throughput, duration, inter-axis crosstalk error, and the like.

FIG. 3 illustrates a process flow diagram depicting a method for generating adjusted sample maps, in accordance with one or more embodiments of the present disclosure.

In embodiments, the one or more path adjustment algorithms 113 may be configured to adjust a path of a set of site points on a given sample map by adjusting an order of arrival of the set of site points based on the respective cost function. For example, the controller 108, using the one or more path adjustment algorithms 113, may be configured to identify one or more characteristics of the given sample map and apply a respective adjustment algorithm based on the identified one or more path parameters. For instance, the one or more path adjustment algorithms 113 may generate one or more temporary sample maps based on the cost function, such that a final sample map may be generated when one or more predetermined stop conditions are met. The one or more predetermined stop conditions may include, but are not limited to, maximum number of iterations, improvement from the previous run was below a predetermined threshold (e.g., less than a determined duration defined by a user), or the like.

In an optional step 402, a zigzag path adjustment algorithm may be applied to adjust an order of arrival of the set of site points on the initial sample map (received in step 202).

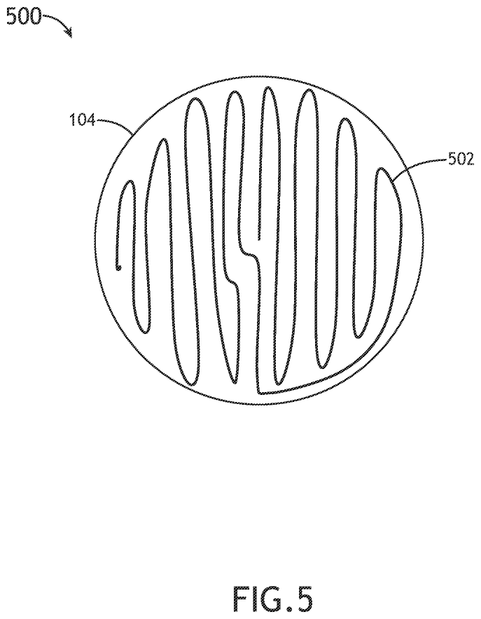

FIG. 5 illustrates a sample map 500 including an initial rough zigzag path 502, in accordance with one or more embodiments of the present disclosure.

In embodiments, the controller 108, using the zigzag path adjustment algorithm, may be configured to generate a zigzag path 502 for a given sample map 500 based on the system's motion dynamics.

It is contemplated herein that the optical sub-system may not be symmetrical (e.g., movement on one axis is slower or faster than the other axis). As such, it may be beneficial to have the majority of the motions along the faster axis. For example, the zigzag path 502 may take advantage of the faster axis and create an initial rough path that is taking into consideration the faster axis.

In a step 404, a point relocation adjustment algorithm may be applied to adjust an order of arrival of the set of site points on a given sample map. For example, the controller 108 may be configured to identify one or more relocation points on the given sample map (e.g., initial sample map received in step 202 or a sample map generated after the zigzag algorithm has been applied in step 402) and adjust an order of arrival based on the relocated point(s). In embodiments, the relocation point may be identified based on the cost function. For example, the controller 108 may apply a cost function to locate a point on the map that if it will be moved to a different location (not physically but on the order of arrival) the overall duration will be shorter. As such, if the cost is lower, the point will be relocated.

As an illustrative example, if the original order of the initial path was 1, 2, 3, 4, 5 and point 2 is identified as a relocation point, the order of arrival may be adjusted to move point 2 to the 4th place, such that the order of the adjusted path is now 1, 3, 4, 2, 5 after the point relocation algorithm has been applied.

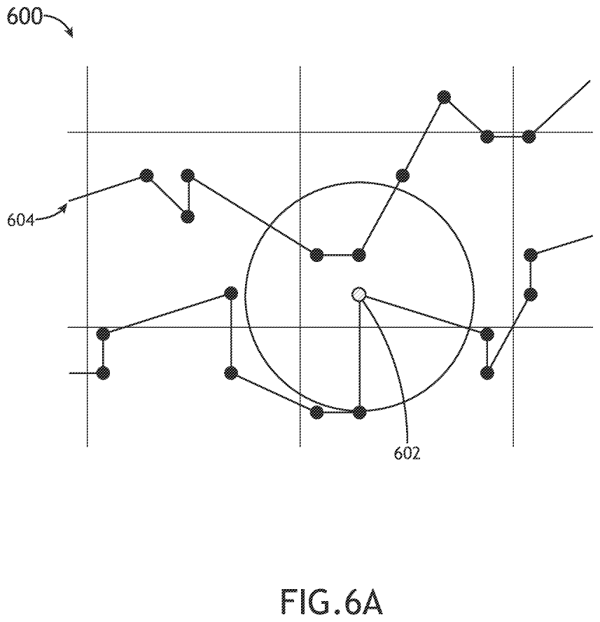

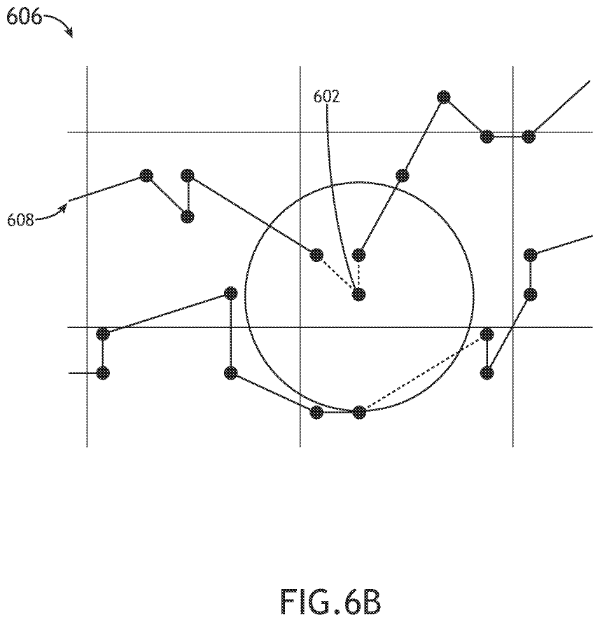

FIG. 6A illustrates a sample map 600 including one or more identified relocation points 602, in accordance with one or more embodiments of the present disclosure. FIG. 6B illustrates an adjusted sample map 606, in accordance with one or more embodiments of the present disclosure.

In embodiments, the controller 108 may be configured to identify a relocation point 602 on a given sample map 600, as shown in FIG. 6A, where the initial path 604 associated with the given sample map 600 has a first duration (or first distance). In embodiments, the controller 108 may be configured to adjust an order of arrival of the relocation point 602 on the given sample map 600 to generate an adjusted sample map 606 including an adjusted path 608, as shown in FIG. 6B, where the adjust path 608 is based on the adjusted order of arrival of the relocation point 602.

It is noted that FIGS. 6A-6B are provided merely for illustrative purposes. Although the paths 604, 608 are depicted as two separated paths, it is contemplated herein that the paths 604, 608 may be considered continuous paths.

In a step 406, a knot removal adjustment algorithm may be applied to adjust an order of arrival of the set of site points on a given sample map. For example, the controller 108 may be configured to identify one or more knots (or crossings) on the given sample map (e.g., initial sample map received in step 202 or sample map generated based on the point relocation algorithm in step 404) and adjust an order of arrival based on the identified knots. In embodiments, knot removal may be identified based on the cost function. For example, the controller 108 may apply a cost function to locate a knot (or crossing) on the map and reorder the path at the knot so there will be no knot (or crossing), such that the overall duration (and distance) will be shorter.

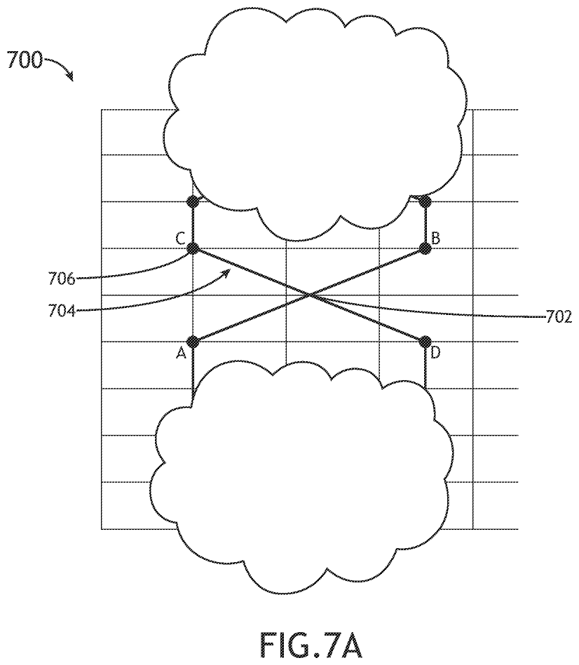

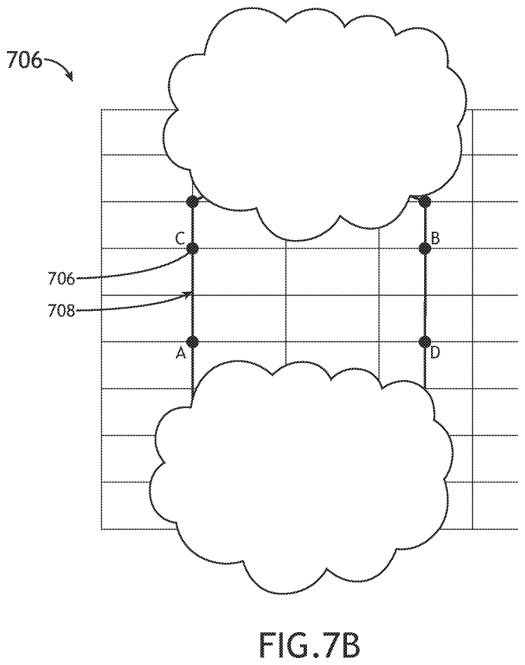

FIG. 7A illustrates a sample map 700 including a crossing area 702, in accordance with one or more embodiments of the present disclosure. FIG. 7B illustrates an adjusted sample map 706 without the crossing area 702 shown in FIG. 7A, in accordance with one or more embodiments of the present disclosure.

In embodiments, the controller 108 may be configured to identify a crossing area 702 (or knot 702) on a given sample map 700, as shown in FIG. 7A, where the initial path 704 associated with the given sample map 700 has a first duration (or first distance). In embodiments, the controller 108 may be configured to adjust an order of arrival of one or more points 705 associated with the crossing area 702 (or knot 702) on the given sample map 700 to generate an adjusted sample map 706 including an adjust path 708, as shown in FIG. 7B, where the adjusted path 708 is based on the adjusted order of arrival of the one or more points 705. For example, the order of arrival of the one or more points 705 may be changed from A, B, C, D (as shown in FIG. 7A) to A, C, B, D (as shown in FIG. 7B), such that the crossing area 702 (or knot 702) is removed.

In a step 408, a section relocation adjustment algorithm may be applied to adjust an order of arrival of the set of site points on a given sample map. For example, the controller 108 may be configured to identify two or more consecutive relocation points on the given sample map (e.g., a sample map generated after the knot removal algorithm has been applied in step 306) and adjust an order of arrival based on the relocated two or more points. In embodiments, the two or more relocation points may be identified based on the cost function. For example, the controller 108 may apply a cost function to locate a section on the map including two or more relocation points that if it section be moved to a different location (not physically but on the order of arrival) the overall duration will be shorter. As such, if the cost is lower, the section including the two or more points will be relocated.

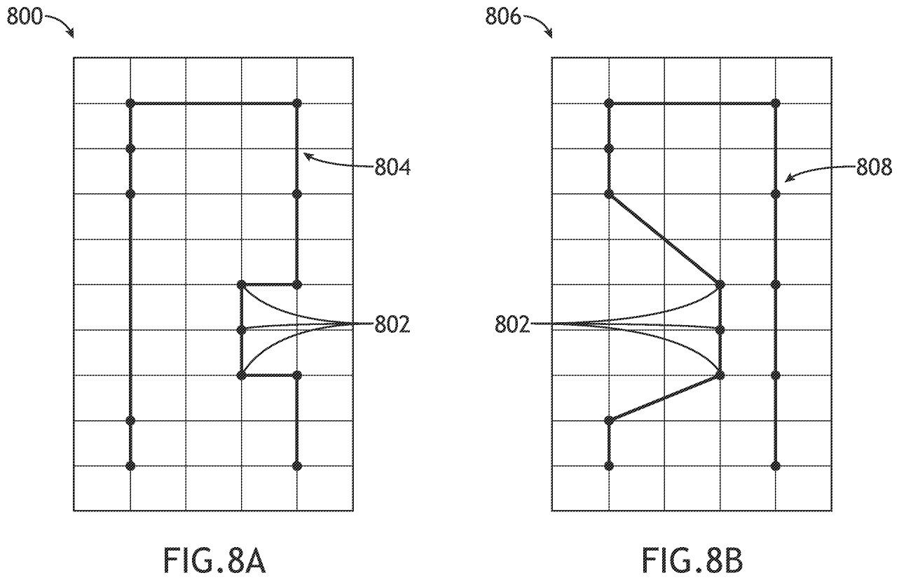

FIG. 8A illustrates a sample map 800 including one or more identified section relocation points 802, in accordance with one or more embodiments of the present disclosure. FIG. 8B illustrates an adjusted sample map 806, in accordance with one or more embodiments of the present disclosure.

In embodiments, the controller 108 may be configured to identify two or more section relocation points 802 on a given sample map 800, as shown in FIG. 8A, where the initial path 804 associated with the given sample map 800 has a first duration (or first distance). In embodiments, the controller 108 may be configured to adjust an order of arrival of the two or more section relocation points 802 on the given sample map 800 to generate an adjusted sample map 806 including an adjusted path 808, as shown in FIG. 8B, where the adjust path 808 is based on the adjusted order of arrival of the two or more relocation points 802.

As an illustrative example, if the original order of the initial path was 1, 2, 3, 4, 5, 6, 7, 8, 9, 10, 11, 12, 13 and points 9, 10, 11 are identified as a section relocation, the order of arrival may be adjusted to move points 9, 10, 11 to the 3rd, 4th, and 5th place respectively, such that the order of the adjusted path is now 1, 2, 9, 10, 11, 12, 3, 4, 5, 6, 7, 8, 12, 13 after the section relocation algorithm has been applied.

In a step 410, it is determined whether a stop condition has been met. For example, the controller 108 may be configured to receive the one or more stop conditions from a user (or external sub-system). For instance, the one or more predetermined stop conditions may include, but are not limited to, maximum number of iterations, improvement from the previous run was below a predetermined threshold (e.g., less than a determined duration defined by a user), or the like.

If one or more of the stop conditions have not been met, the system may be configured to perform one or more of steps 404, 406, or 408 again, until the one or more stop conditions have been met.

If the one or more stop conditions have been met, the method proceeds to step 206.

Referring to FIG. 2, in a step 206, a final sample map may be generated based on the one or more adjusted paths. For example, the controller 108 may be configured to generate the final sample map based on the sample map created by the previous run (e.g., from step 308), where the final sample map has met the one or more stop conditions.

The final sample map of the sample 104 may include a final path, where the final path is formed of the set of site points 304 (from the initial sample map 300) on the sample 104. For example, the final path of the set of site points 304 on the sample 104 may correspond to site points on the sample 104 that the optical sub-system 102 needs to pass during operation.

In a step 208, the optical sub-system 102 may perform one or more operations based on the final sample path. For example, the final sample map including the final path may be stored in memory 112 and provided to the optical sub-system 102. For instance, the controller 108 may direct the optical sub-system 102 to perform the one or more operations on the sample 104 based on the stored final sample map.

In embodiments, where the optical sub-system 102 includes an inspection sub-system, the inspection sub-system may be configured to perform one or more inspection operations based on the final path of the final sample map.

In embodiments, where the optical sub-system 102 includes a metrology sub-system, the metrology sub-system may be configured to perform one or more metrology operations (or measurement operations) based on the final path of the final sample map.

In embodiments, where the optical sub-system 102 includes a lithography sub-system, the lithography sub-system may be configured to perform one or more lithography operations based on the final path of the final sample map.

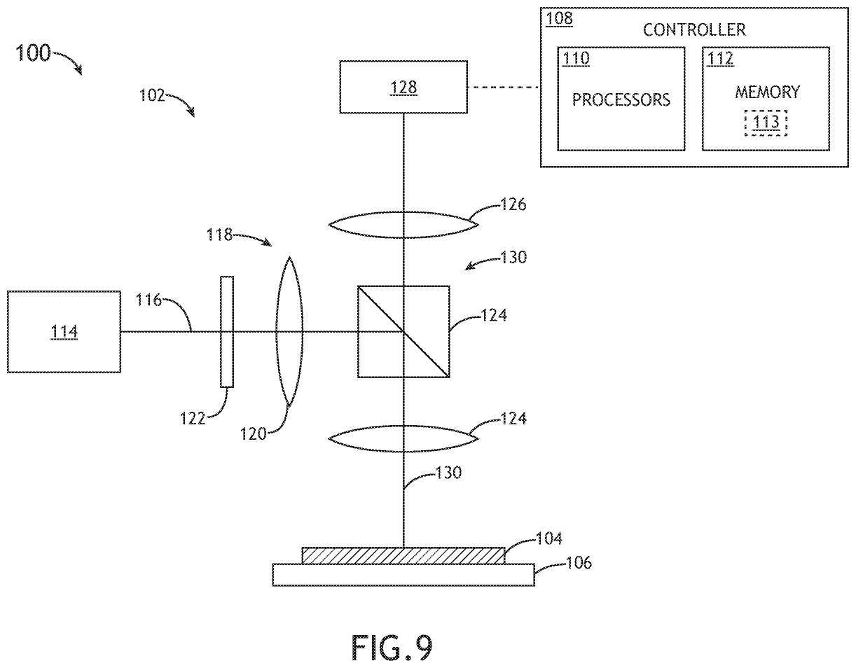

FIG. 9 illustrates an inspection sub-system 102, in accordance with one or more embodiments of the present disclosure. It is noted that the optical sub-system 102 may include any type of optical sub-system 102 known in the art. For example, the optical sub-system 102 may include an inspection sub-system (or an inspection tool). For instance, the inspection sub-system may include an optical-based inspection tool such as, but is not limited to, a bright-field inspection sub-system, a dark-field inspection system, or the like. By way of another example, the optical sub-system 102 may include a metrology sub-system (or a metrology tool). For instance, the metrology sub-system may include an optical-based metrology tool. By way of another example, the optical sub-system 102 may include a lithography sub-system (or a lithography tool). The one or more samples 104 may include any sample known in the art including, but not limited to, a wafer, a reticle/photomask, and the like. The sample stage assembly 106 may include any sample stage assembly 106 known in the art including, but not limited to, an X-Y stage, an R-θ stage, and the like. In embodiments, the sample stage assembly 106 is capable of adjusting the height of the one or more samples 104 during inspection or imaging to maintain focus on the one or more samples 104.

In embodiments, the inspection sub-system 102 includes an illumination source 114 to generate an illumination beam 116. The illumination beam 116 may include one or more selected wavelengths of light including, but not limited to, ultraviolet (UV) radiation, visible radiation, or infrared (IR) radiation.

In embodiments, the illumination source 114 directs the illumination beam 116 to the sample 104 via an illumination pathway 118. The illumination pathway 118 may include one or more lenses 120. Further, the illumination pathway 118 may include one or more additional optical components 122 suitable for modifying and/or conditioning the illumination beam 116. For example, the one or more optical components 122 may include, but are not limited to, one or more polarizers, one or more filters, one or more beam splitters, one or more diffusers, one or more homogenizers, one or more apodizers, or one or more beam shapers.

In embodiments, the illumination pathway 118 includes a beamsplitter 124. In embodiments, the inspection sub-system 102 includes an objective lens 126 to focus the illumination beam 116 onto the sample 104.

In embodiments, the inspection sub-system 102 includes one or more detectors 128 configured to capture radiation emanating from the sample 104 through a collection pathway 130. The collection pathway 130 may include multiple optical elements to direct and/or modify illumination collected by the objective lens 126 including, but not limited to one or more lenses, one or more filters, one or more polarizers, one or more beam blocks, or one or more beamsplitters. For example, the detector 128 may receive an image of the sample 104 provided by elements in the collection pathway 130 (e.g., the objective lens 126, the one or more lenses, or the like). By way of another example, the detector 128 may receive radiation reflected or scattered (e.g., via specular reflection, diffuse reflection, and the like) from the sample 104. By way of another example, the detector 128 may receive radiation generated by the sample (e.g., luminescence associated with absorption of the illumination beam 116, and the like). Further, it is noted herein that the one or more detectors 128 may include any optical detector known in the art suitable for measuring illumination received from the sample 104. For example, the detector 128 may include, but is not limited to, a charge coupled device (CCD) detector, a time delay and integration (TDI) detector, a photomultiplier tube (PMT), an avalanche photodiode (APD), or the like.

In embodiments, the one or more processors 110 of controller 108 may include any processing element known in the art. In this sense, the one or more processors 110 may include any microprocessor-type device configured to execute algorithms and/or instructions. In one embodiment, the one or more processors 110 may consist of a desktop computer, mainframe computer system, workstation, image computer, parallel processor, or any other computer system (e.g., networked computer) configured to execute a program configured to operate the system 100, as described throughout the present disclosure. It is further recognized that the term “processor” may be broadly defined to encompass any device having one or more processing elements, which execute program instructions from a non-transitory memory medium 112. Therefore, the above description should not be interpreted as a limitation on the present invention but merely an illustration.

The memory medium 112 may include any storage medium known in the art suitable for storing program instructions executable by the associated one or more processors 110. By way of a non-limiting example, the memory medium 112 may include a non-transitory memory medium. By way of additional non-limiting examples, the memory medium 112 may include, but is not limited to, a read-only memory (ROM), a random-access memory (RAM), a magnetic or optical memory device (e.g., disk), a magnetic tape, a solid-state drive (SSD), and the like. It is further noted that the memory 112 may be housed in a common controller housing with the one or more processors 110. In an alternative embodiment, the memory 112 may be located remotely with respect to the physical location of the one or more processors 110 and controller 108. For instance, the one or more processors 110 of the controller 108 may access a remote memory (e.g., server), accessible through a network (e.g., internet, intranet and the like).

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include, but not be limited to, systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include, but not be limited to, systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A system comprising:
a controller including one or more processors configured to execute program instructions causing the one or more processors to:
receive an initial sample map of a sample, wherein the initial sample map includes an initial path including a set of site points, wherein the initial path includes a first duration and a first distance;
generate one or more adjusted sample maps including one or more adjusted paths of the set of site points of the initial sample map, wherein each adjusted path is generated by adjusting an order of arrival of the set of site points based on a cost function;
generate a final sample map of the sample based on the one or more adjusted paths, wherein the final sample map includes a final path generated based on the one or more adjusted order of arrivals of the set of site points; and
direct an optical sub-system to perform one or more operations on the sample based on the final sample map, wherein the optical sub-system performs the one or more operations by following the final path of the set of site points on the sample, wherein the final path has a second duration and a second distance, wherein at least one of the first duration or the first distance of the initial path are greater than at least one of the second duration or the second distance of the final path.

2. The system of claim 1, wherein the optical sub-system comprises an inspection sub-system, wherein the set of site points include a set of inspection points on the sample.

3. The system of claim 1, wherein the optical sub-system comprises a metrology sub-system, wherein the set of site points include a set of metrology measurement points on the sample.

4. The system of claim 1, wherein the optical sub-system comprises a lithography sub-system, wherein the set of site points include a set of lithography points on the sample.

5. The system of claim 1, wherein the order of arrival of the set of site points of the initial path is adjusted by generating a zigzag initial path based on a motion characteristic of the optical sub-system.

6. The system of claim 1, wherein the order of arrival of the set of site points of the initial path is adjusted by adjusting a location in time of a site point.

7. The system of claim 1, wherein the order of arrival of the set of site points of the initial path is adjusted by adjusting two or more locations in time of two or more site points, wherein the two or more site points are arranged consecutively in the initial path of the initial sample map.

8. The system of claim 1, wherein the initial path includes a crossing area formed by two or more site points.

9. The system of claim 8, wherein the order of arrival of the set of site points of the initial path is adjusted by:
removing the crossing area from the initial path by adjusting a location in time of the two or more site points forming the crossing area.

10. The system of claim 1, wherein the program instructions are further configured to cause the one or more processors to:
generate an initial rough path by adjusting one of an x-axis or a y-axis of the initial sample map.

11. The system of claim 1, wherein the cost function is based duration.

12. A system comprising:
an optical sub-system; and
a controller communicatively coupled to the optical sub-system, the controller including one or more processors configured to execute program instructions causing the one or more processors to:
receive an initial sample map of a sample, wherein the initial sample map includes an initial path including a set of site points, wherein the initial path of the initial sample map has a first duration and a first distance;
generate one or more adjusted sample maps including one or more adjusted paths of the set of site points of the initial sample map, wherein each adjusted path is generated by adjusting an order of arrival of the set of site points based on a cost function;
generate a final sample map of the sample based on the one or more adjusted paths, wherein the final sample map includes a final path generated based on the one or more adjusted order of arrivals of the set of site points; and
direct the optical sub-system to perform one or more operations on the sample based on the final sample map, wherein the optical sub-system performs the one or more operations by following the final path of the set of site points on the sample, wherein the final path has a second duration and a second distance, wherein at least one of the first duration or the first distance of the initial path are greater than at least one of the second duration or the second distance of the final path.

13. The system of claim 12, wherein the optical sub-system comprises an inspection sub-system, wherein the set of site points include a set of inspection points on the sample.

14. The system of claim 12, wherein the optical sub-system comprises a metrology sub-system, wherein the set of site points include a set of metrology measurement points on the sample.

15. The system of claim 12, wherein the optical sub-system comprises a lithography sub-system, wherein the set of site points include a set of lithography points on the sample.

16. The system of claim 12, wherein the order of arrival of the set of site points of the initial path is adjusted by adjusting a location in time of a site point.

17. The system of claim 12, wherein the order of arrival of the set of site points of the initial path is adjusted by adjusting two or more locations in time of two or more site points, wherein the two or more site points are arranged consecutively in the initial path of the initial sample map.

18. The system of claim 12, wherein the initial path includes a crossing area formed by two or more site points.

19. The system of claim 18, wherein the order of arrival of the set of site points of the initial path is adjusted by:
removing the crossing area from the initial path by adjusting a location in time of the two or more site points forming the crossing area.

20. The system of claim 12, wherein the program instructions are further configured to cause the one or more processors to:
generate an initial rough path by adjusting one of an x-axis or a y-axis of the initial sample map.

21. The system of claim 12, wherein the cost function is based on duration.

22. A method comprising:
receiving an initial sample map of a sample, wherein the initial sample map includes an initial path including a set of site points, wherein the initial path includes a first duration and a first distance;
generating one or more adjusted sample maps including one or more adjusted paths of the set of site points of the initial sample map, wherein each adjusted path is generated by adjusting an order of arrival of the set of site points based on a cost function;
generating a final sample map of the sample based on the one or more adjusted paths, wherein the final sample map includes a final path generated based on the one or more adjusted order of arrivals of the set of site points; and
directing an optical sub-system to perform one or more operations on the sample based on the final sample map, wherein the optical sub-system performs the one or more operations by following the final path of the set of site points on the sample, wherein the final path has a second duration and a second distance, wherein at least one of the first duration or the first distance of the initial path are greater than at least one of the second duration or the second distance of the final path.
